(19) United States
(12) Patent Application Publication
(10) Pub. No.: US 2011/0042108 A1
(43) Pub. Date: Feb. 24, 2011

(54) PORTABLE COMPRESSED GAS FOAM SYSTEM

(76) Inventor: Kurt Hiebert, Penticton (CA)

Correspondence Address: Smiths IP, Suite #330, 1508 West Broadway, Vancouver, BC, V6JIW8, CA

(21) Appl. No.: 12/867,707

(22) PCT Filed: Feb. 16, 2009
(86) PCT No.: PCT/CA2009/000187

§ 371 Date: Oct. 21, 2010

Related U.S. Application Data
(60) Provisional application No. 61/029,264, filed on Feb. 15, 2008.

(51) Int. Cl. A62C 11/00; B01F 3/04

(52) U.S. Cl. 169/30; 261/119.1; 261/65

(57) ABSTRACT

A portable compressed gas foam system having a rocket engine, fueled with hydrogen peroxide and a suitable propellant, which produces exhaust gases. The exhaust gases are injected into a water tank, aerating the water and pressurizing the water tank. Foam concentrate may be added to the tank or separately in a mixing stage and is aerated by the aerated and pressurized water. The aeration produces bubbles in the foam and entrains exhaust gas within the bubbles. The aerated foam can then be sprayed onto a fire through a foam injection nozzle, extinguishing the fire both by wetting the burning materials and by smothering it by reducing the amount of oxygen available to burn. The invention may also be adapted for use in a firehose or in an underslung bucket.

### TECHNICAL FIELD OF THE INVENTION

This invention relates to a portable compressed gas foam system, sometimes called a Compressed Air Foam System (CAFS), used to create and to apply foam in order to extinguish a fire, to deliver pesticides or to deliver hazardous material cleanup products.

### BACKGROUND OF THE INVENTION

Fires cause tremendous damage and destruction every year. Various means to extinguish fires have been employed, including water, chemicals and mixtures of the two. If water alone is used, much of the water applied tends to evaporate before penetrating the fire, thereby requiring more applications of water in order to fully extinguish a fire. This can lead to extensive water damage to the surrounding areas, as well as requiring more time and resources to fully extinguish the fire. Further, some fires do not respond well to water. Chemicals can be very effective at smothering a fire, but can be expensive and can damage and contaminate the surrounding areas. Foaming compounds delivered by a CAFS have been useful in overcoming some of the problems associated with water-only systems or chemicals.

Nonetheless, CAFS systems do suffer from drawbacks. It is important with any portable firefighting system to minimize the weight and space required to carry the required equipment and the required materials (i.e. compressed gas, water, foam), in order to produce and dispense as much foam as possible before the fire fighting vehicle must leave the fire to replenish its supplies. As the space and weight requirements for the fire fighting system components increase, less space remains for the water, foam concentrate and other consumable elements of the system. For this reason, foam is typically produced using small containers of foam concentrate, which is then mixed with water to expand the concentrate into foam. The addition of gas to the water and concentrate mixture aerates the foam, producing an even greater volume of foam in relation to the initial volume of concentrate. Portable fire fighting systems typically seek to maximize the volume of foam produced by given volumes of foam concentrate and water.

Once the foam reaches the fire, the bubbles within the foam begin to burst and release the gas trapped inside the bubbles. If the aerating gas is air, which is often the cheapest and most readily available gas, this process can continue to feed a fire, as air is typically composed of approximately 21 percent flammable oxygen.

One means of overcoming this problem is to employ foam that has been aerated with a gas other than air, for example a non-combustible gas such as carbon dioxide. However, such a system requires a source of the non-combustible gas. This source is very often a tank of compressed gas, which tends to be heavy and bulky due to the strength requirements of the tank to properly contain the gas, and which carries its own dangers associated with transporting and using the gas contained within the tank. It is therefore also known to use another source of gas such as an inert gas generator; however, systems using inert gas generators, such as those disclosed in U.S. Pat. No. 4,614,237, issued Apr. 15, 1969 and U.S. Pat. No. 2,961,050, issued Nov. 22, 1960, both to McCracken, also tend to be unwieldy, as the gas generators themselves are fairly large.

U.S. Pat. No. 6,688,402, issued Feb. 10, 2004 to Wise discloses an aerial fire fighting system including a turbo motor, a catalytic converter connected to the turbo motor to convert the carbon dioxide and carbon monoxide emitted by the turbo motor into heated carbon dioxide. The converted carbon dioxide is cooled by a condensing unit and fed into a foam chamber. The foam chamber may be vented to relieve any excess pressure. A foam concentrate reservoir is carried on the aircraft, and a water reservoir is contained in a bucket slung underneath the aircraft. Remotely controlled valves are opened to allow water to fall from the reservoir into a foam chamber in the lower portion of the bucket, and to bring foam concentrate into the foam chamber. Under the pressure from the carbon dioxide, the water and foam are forced through a screen in the bottom of the bucket, creating carbon dioxide foam which is dispensed onto the fire.

Various sources of non-combustible gas with which to pressurize a foam-based fire fighting system and to aerate the foam have also been considered. U.S. Pat. No. 5,575,341, issued Nov. 19, 1996 to Baker suggests compressed gas tanks, engine exhaust, a commercially available gas generator, or shipboard flue gas if the fire fighting apparatus is being carried aboard a ship. U.S. Pat. No. 6,311,780, issued Nov. 6, 2001 to Zuev et al. suggests a turbocompressor unit, as part of a standard turbojet engine. U.S. Pat. No. 2,198,585, issued Apr. 23, 1940 to Urquhart et al. also discloses the use of vehicle engine exhaust (such as the exhaust of a fire truck on which the system is mounted) or flue gases (if the system is located aboard a ship). While usefully employing gases provided by the exhaust of the fire fighting platform vehicle, such systems are of limited use in that they rely on the vehicle itself for their functioning.

Baker et al. more specifically discusses the need to entrain carbon dioxide bubbles within a fire fighting foam, in order to exclude air as much as possible. Baker uses a foaming chamber in which a liquid, a foam concentrate and a non-combustible gas are mixed. The non-combustible gas may be the exhaust of an engine, may be generated by a commercially available gas generator, or may simply be carried in a compressed gas tank. The use of carbon dioxide or specialized fire extinguishing gases such as Halon is suggested. Foam is created by turbulence caused when the liquid, foam concentrate and non-combustible gas mix within the foaming chamber. Bubbles within the foam are filled with the non-combustible gas, thereby creating an inert mechanical foam, which helps in choking the fire when the bubbles burst.

Typically, as in the cases of Baker and Wise, water, foam concentrate and gas are mixed simultaneously in a mixing chamber, rather than pre-mixing any of the components. Other systems, such as that disclosed by U.S. Pat. No. 4,979,571, issued Dec. 25, 1990 to MacDonald, mix water and concentrate first, and then inject a non-combustible gas into the mixture to increase the volume of foam produced and to delay the expansion of the resulting foam, allowing more accurate application of the foam in a helicopter-based system.

U.S. Pat. No. 4,729,434, issued Mar. 8, 1988 to Rohrbach discloses a portable fire fighting apparatus comprising a tank of water and a tank of foam concentrate, as well as a tank of a chemical fire extinguishing agent, such as Halon. A source of pressurized fluid, such as compressed nitrogen gas, is connected to both the water tank and the foam concentrate tank, and forces water and foam concentrate out of the tanks, to mix in a foam inductor. The foam is then dispensed through a hose, as necessary. Any overpressure within the water tank is vented to the atmosphere via a pressure release valve at the top of the water tank. A similar pressure relief system is shown in U.S. Pat. No. 3,977,474, issued Aug. 31, 1976 to Boegli. However, the venting of excess gas into the surrounding atmosphere makes the system less suitable for indoor use, necessitating the use of self contained breathing apparatus. The venting of excess gas to the atmosphere is also a waste of gas that could be applied elsewhere in the system.

The present invention is directed to an improved transportable apparatus for a compressed gas foam system which is capable of producing relatively large volumes of foam.

### SUMMARY OF THE INVENTION

The preferred embodiment of the invention comprises a rocket engine, fueled with hydrogen peroxide and a suitable fuel such as an alcohol, diesel fuel or kerosene, which produces exhaust gases, such as carbon dioxide, nitrogen carbon monoxide and water vapor. The exhaust gases are injected into a water tank, saturating or partially saturating the water with gases and pressurizing the water tank. Gas-saturated water flows from the tank to a mixing chamber, along with any over-pressure gas from the water tank. Foam concentrate flows from a second, smaller tank to the mixing chamber, where it mixes with the water and excess gases, aerating the foam concentrate. The effect of the gases will be to produce bubbles in the foam and entrain the emissions gas within those bubbles. The aerated foam can then be sprayed onto a fire through suitable means such as a foam injection nozzle, smothering it by reducing the amount of oxygen available to burn.

It is anticipated that the apparatus will be carried on a helicopter, but it may also be used on other vehicles, including land based fire trucks, ships and heavy equipment. The apparatus may also be adapted for use inline within a firehose, or may be adapted for use with an underslung airborne helicopter bucket, such as a Bambi Bucket™. The apparatus may also be installed in buildings, such as airplane hangars, in which small size and lack of required maintenance are a benefit.

In one aspect, the invention comprises a portable apparatus for a compressed gas foam system comprising a first chamber for receiving a first fluid suitable for generating exhaust gases in a reaction wherein the exhaust gases from the reaction are directed through a water chamber attached to the first chamber to cause the gases to partially dissolve in the water and to pressurize the water chamber.

In another aspect, the invention comprises a portable apparatus for a compressed gas foam system comprising a first chamber attached to a second chamber. The first chamber is adapted to receive a first fluid suitable for generating exhaust gases in a reaction. The second chamber is in operative relationship to the first chamber to allow the gases to be directed through the second chamber and through a volume of water in the second chamber whereby to partially dissolve the gases in the water and to pressurize the second chamber for expelling water therefrom under pressure.

In a further aspect, the apparatus comprises a gas pressure relief valve on the water chamber. An outlet of said gas pressure relief valve is in fluid communication with a mixer wherein foam concentrate and water under pressure are mixed with the overpressure gases. The foam concentrate and water may be mixed in the water chamber or in the mixer.

In a further aspect, the apparatus comprises means for mixing water under pressure with foam concentrate dispensed from a foam concentrate vessel to produce a stream of pressurized foam.

In another aspect, the invention comprises a compressed gas foam system. A first chamber receives a first fluid suitable for generating exhaust gases in a reaction. The exhaust gases are used to pressurize a water chamber. A gas pressure relief valve is provided on the water chamber. An outlet of the gas pressure relief valve is in fluid communication with a mixer wherein foam concentrate and water under pressure are mixed. The concentrate and water may be mixed in the water chamber or in the mixer.

More specifically, the apparatus is a portable compressed gas foam system that integrates an engine for producing non-combustible exhaust gases with a water vessel and that uses the non-combustible exhaust gases both to aerate the water and to pressurize the water vessel. The aerated water is delivered under pressure to be mixed with foam concentrate. Delivery of the foam concentrate may also be facilitated by pressure derived from the non-combustible exhaust gases.

More specifically, the engine for producing non-combustible exhaust gases consists of a vessel for containing a volume of a reactive substance, a means for exposing the reactive substance in the vessel to a catalyst to cause a metered volume of the reactive substance to catalyze into gas products. A combustion chamber receives the gas products and a combustion fuel supply line feeds into the combustion chamber. The combustion chamber is in fluid communication with the bottom of a water vessel such that the combustion gases percolate under pressure through water in the vessel. A water outlet conduit delivers water under pressure to a mixing stage where it is mixed with foam concentrate delivered from a foam concentrate container.

In another aspect of the invention, the engine for producing non-combustible exhaust gases comprises a substance or mix of substances that produce a relatively large volume of output gases when undergoing a reaction or combustion. In the preferred embodiment, the engine comprises a source of hydrogen peroxide that is catalyzed by contact with a metallic mesh screen to produce oxygen gas and water vapor. The oxygen gas is fed to a combustion chamber which a propellant, such as alcohol, diesel fuel or kerosene, is fed. Ignition of the propellant under the heat and compression within the engine burns up the oxygen gas and produces a high volume of non-combustible gases, namely carbon dioxide, nitrogen, carbon monoxide and water vapor.

In a further aspect, the invention comprises a portable compressed gas foam system to dispense foam, comprising a first fluid vessel, adapted to store a quantity of water. A hydrogen peroxide rocket engine is in fluid communication with the first fluid vessel to pressurize the first fluid vessel with exhaust from the hybrid engine. At least one fuel source is in fluid communication with the hybrid engine. A first fluid conduit connects the first fluid vessel to a mixing chamber. A second fluid conduit connects a second fluid vessel to the mixing chamber. The second fluid vessel is adapted to store a quantity of foam concentrate. An outlet connects the mixing chamber to a dispensing mechanism and a gas conduit transfers excess gas from the first fluid vessel to the mixing chamber.

In another aspect, the invention comprises a portable fire fighting apparatus to dispense fire fighting foam, comprising a first fluid vessel, adapted to store a quantity of water; a hydrogen peroxide rocket engine in fluid communication with the first fluid vessel to pressurize the first fluid vessel with exhaust from the rocket engine; at least one fuel source in fluid communication with the rocket engine; a first fluid conduit connecting the first fluid vessel to a mixing chamber; a second fluid conduit connecting a second fluid vessel to the first fluid vessel, the second fluid vessel being adapted to store a quantity of fire fighting foam concentrate; an outlet connecting the mixing chamber to a dispensing mechanism; and a gas conduit to transfer excess gas from the first fluid vessel to the mixing chamber.

The foregoing was intended as a broad summary only and of only some of the aspects of the invention. It was not intended to define the limits or requirements of the invention. Other aspects of the invention will be appreciated by reference to the detailed description of the preferred embodiment and to the claims.

### BRIEF DESCRIPTION OF THE DRAWINGS

The preferred embodiment of the invention will be described by reference to the drawings in which:

FIG. 1A is a schematic of an embodiment of the invention;

FIG. 1B is a schematic of an embodiment of the invention;

FIG. 2 is a perspective view of the rocket engine of an embodiment of the invention;

FIG. 3 is a perspective view of the foam mixing stage of an embodiment of the invention;

FIG. 4 is a perspective view of the main cylinder of the foam mixing stage of an embodiment of the invention;

FIG. 5 is a perspective view of the inner diffuser of the foam mixing stage of an embodiment of the invention;

FIG. 6 is a schematic of an embodiment of the compressed gas foam system, inline in a firehose;

FIG. 7A is a top view of a gas generator in an embodiment of the compressed gas foam system, in an underslung helicopter bucket;

FIG. 7B is a side view of an embodiment of the compressed gas foam system, in an underslung helicopter bucket; and

FIG. 7C is a sectional view of the gas generator of FIG. 7A, taken along line A-A.

### DETAILED DESCRIPTION OF A PREFERRED EMBODIMENT OF THE INVENTION

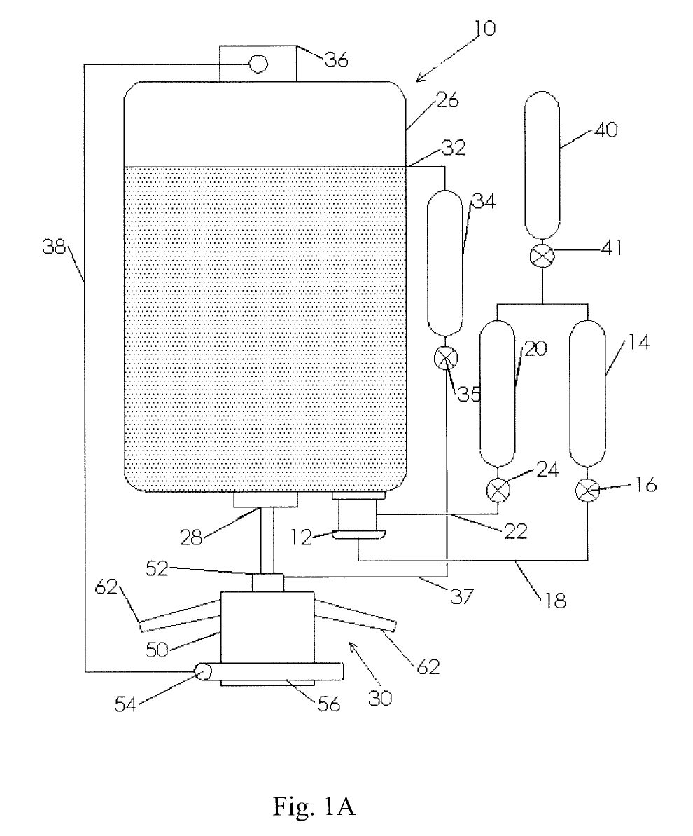

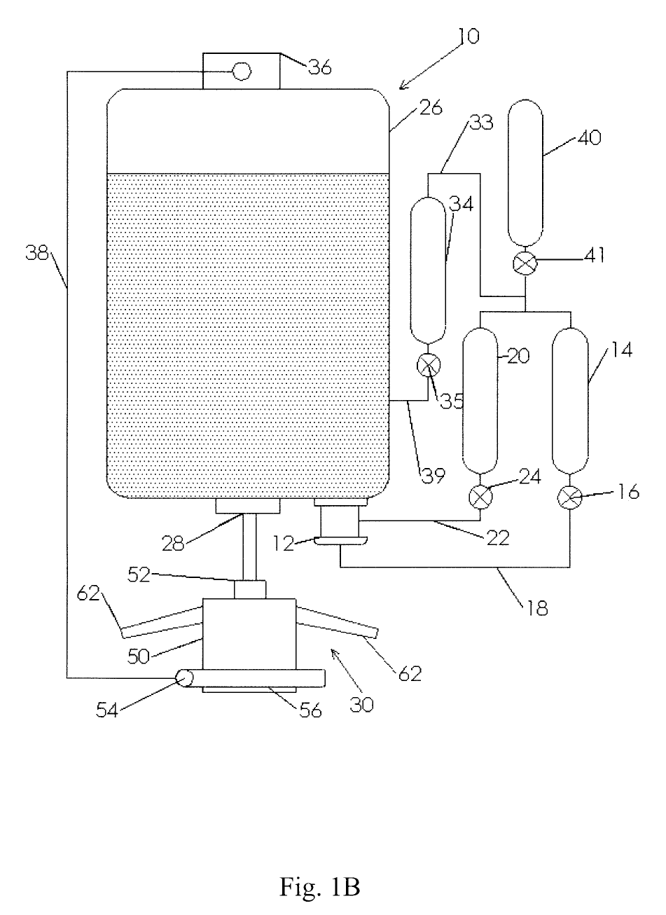

FIGS. 1A and 1B illustrate the apparatus according to an embodiment of the invention. Generally, the apparatus 10 comprises a gas generator consisting of a rocket engine 12, preferably stainless steel or other durable material to withstand the temperatures and pressures generated, fuelled by a quantity of hydrogen peroxide. A limited flow of hydrogen peroxide flows from vessel 14, controlled by metering valve 16 through a feed line 18 into rocket engine 12, which contains a metallic screen (not shown) that acts as a catalyst. The catalytic reaction produces steam and oxygen gas within rocket engine 12.

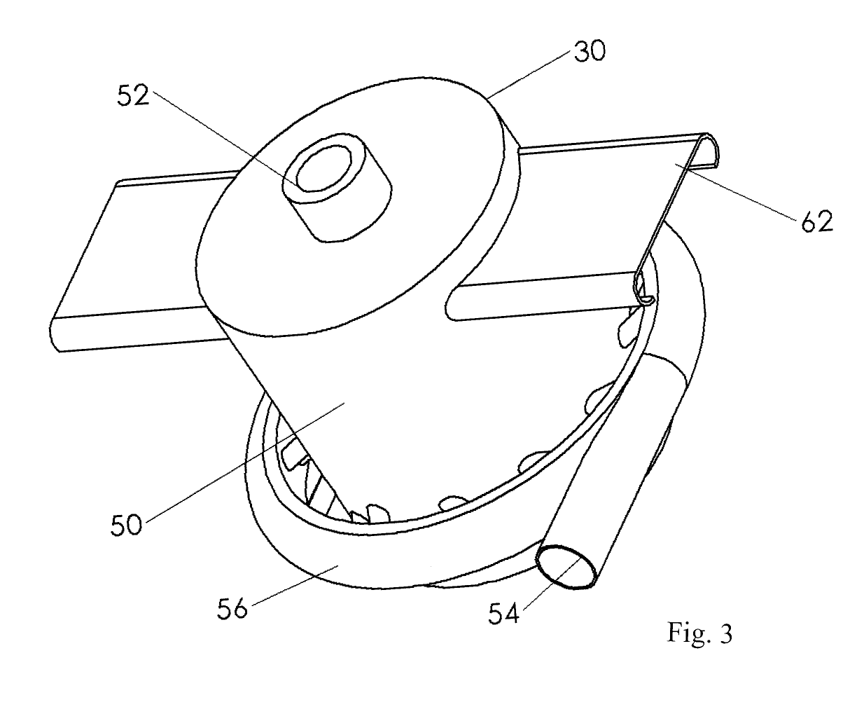

A propellant, such as alcohol, diesel fuel, kerosene or other suitable combustible material, is supplied from vessel 20 through feed line 22, under the control of metering valve 24 to the rocket engine 12 where the build-up of heat and pressure from the steam and oxygen gas produced by the catalytic reaction spontaneously ignites the alcohol and burns the oxygen gas. The resulting exhaust gases are directed through a valve 48 (best shown in FIG. 3) into the bottom of a water vessel 26. A secondary ignition system may be used if necessary to ignite the propellant, or an additive may be used to ensure that the propellant is self-igniting (hypergolic). For example, manganese acetate may be dissolved into an ethanol or methanol propellant to assist in self-ignition of the propellant.

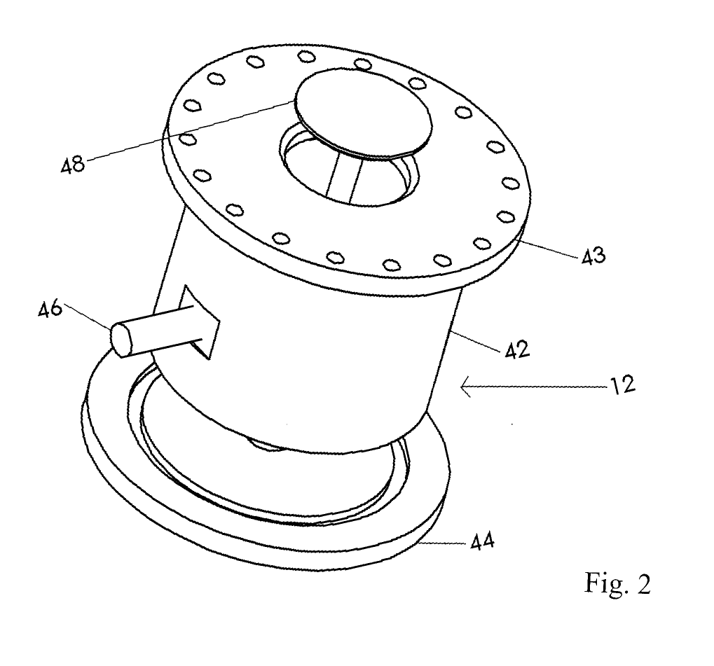

FIG. 2 shows the rocket engine 12 in more detail. The main part of rocket engine 12 is a combustion chamber 42, attached to the water vessel 26 via suitable means such as flange 43. Hydrogen peroxide is injected into the combustion chamber 42 at an end spaced from water vessel 26 via any suitable means, such as injector plate 44. The hydrogen peroxide passes through a catalyst (not shown) within body 42. The catalyst is preferably a metallic mesh, comprised of materials known to catalyze hydrogen peroxide, such as silver, gold, rhodium, palladium, platinum, manganese dioxide or a combination of any or all of these. The hydrogen peroxide decomposes exothermically in the presence of the catalyst, producing oxygen gas and some water vapor (steam), as well as a substantial amount of heat. Propellant, such as alcohol, kerosene, diesel fuel or any other suitable material, is then injected into the combustion chamber 42 through suitable means, such as injector nozzle 46. When the propellant enters combustion chamber 42, it is ignited by the heat from the hydrogen peroxide decomposition, burning off the oxygen gas and creating exhaust gases, namely carbon dioxide, nitrogen, carbon monoxide and water vapor. The pressure of the ignition and subsequent combustion increase the pressure within the combustion chamber 42 until there is enough pressure to open valve 48, injecting the exhaust gases into the water vessel 26 at high pressure.

Referring again to FIG. 1A, the high pressure jet of exhaust gases through the water column within water vessel 26 serve to rapidly aerate the water and to cause a build-up of pressure in the water vessel 26. A high pressure output conduit 28 directs the aerated water to a mixing stage 30 where the water is mixed with a foam concentrate (which may be a fire-fighting foam, a pesticide or other suitable foam concentrate) delivered from a concentrate holding tank 34. A second output conduit 32 equalizes the pressure between water vessel 26 and concentrate holding tank 34, allowing foam concentrate to flow to mixing stage 30 through feed line 37, under the control of metering valve 35. Foam concentrate flows under the pull created as the aerated water passes through conduit 28 into mixing stage 30.

In order to avoid the excessive build-up of pressure in water vessel 26, a gas pressure relief valve 36 is mounted at the top of the vessel 26 for exhausting overpressure gases. In the preferred embodiment, the gases released from the relief valve 36 are fed through one or more gas lines 38 to the mixing stage 30.

Alternatively, as shown in FIG. 1B, the foam concentrate holding tank 34 may be in direct communication with water vessel 26, through conduit 39. Foam concentrate may be forced into the water vessel 26 by pressure from cylinder 40, controlled by valve 41, through conduit 33. Cylinder 40 may be filled with any suitable pressurized gas, such as carbon dioxide. In this embodiment, mixing stage 30 mixes the foam and water mixture received through output conduit 28 with overpressure gas from gas line 38.

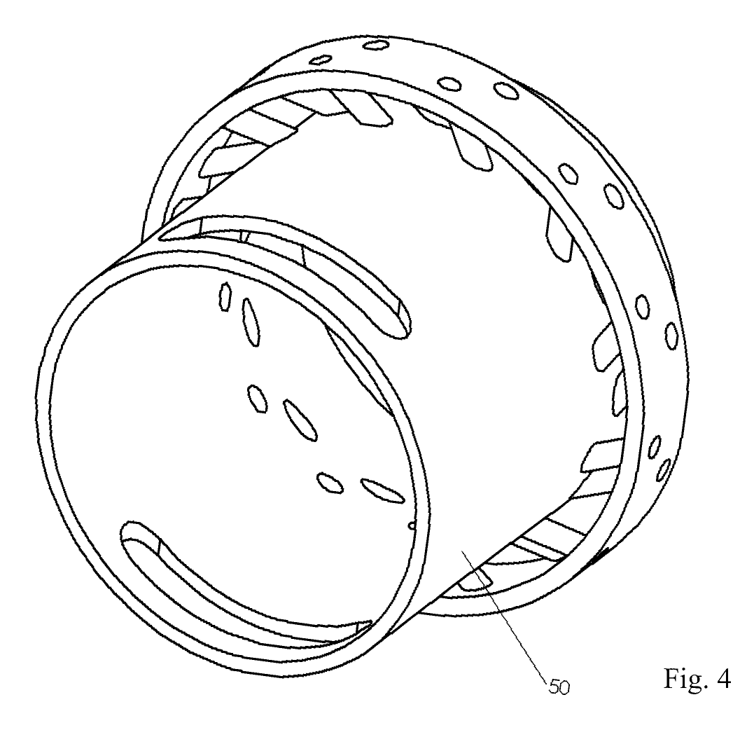

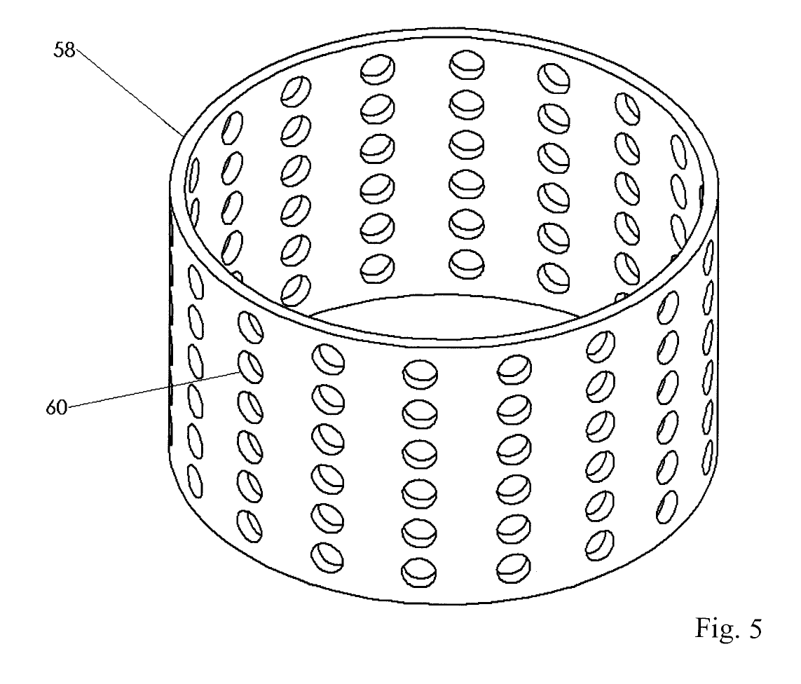

In both embodiments, mixing stage 30 may consist of any suitable container and inlets by which aerated water, foam concentrate and excess gas may be combined and expelled through a dispersion means. In the embodiment illustrated in FIG. 3, mixing stage 30 comprises a foam mixer cylinder 50 (best shown in FIG. 4), which receives the aerated water, foam concentrate and any overpressure gas. Foam concentrate and aerated water enter the mixer cylinder 50 through an upper section 52, while overpressure gas enters the mixing stage 30 through inlets 54 of plenum outer ring 56. Once the foam components are in the cylinder 50, they are mixed and dispersed, flowing about an inner diffuser 58, preferably having several perforations 60 (shown only in FIG. 5) to facilitate mixing and maximizing the volume created by the components. The foam can then be expelled through foam deflectors 62. Even dispersal of the foam may be assisted by a cone or other attachment (not shown) to the mixing stage.

The rocket engine 12 produces a very high volume output of gases for a relatively low volume of hydrogen peroxide and alcohol. This allows the apparatus of the invention to maximize the volume of foam produced while minimizing the volume and footprint of the apparatus, the water and the fuels.

Carbon dioxide, nitrogen, carbon monoxide and water vapor are non-combustible exhaust gases that are suitable to support the production of foam that will assist in smothering rather than feeding the flames. In addition, the high volume output of the rocket engine 12 allows the build-up of a great deal of pressure to effectively aerate the water and to propel the foam.

As the entire apparatus is self contained in terms of fuels and water storage, and because of its relatively small volume, it is portable and suitable to be slung beneath a helicopter or carried on land based fire trucks. The apparatus also has the advantage that it is not dependent on a source of vehicle exhaust as it includes its own exhaust engine.

The small footprint and self-contained nature of the apparatus further enables the apparatus to be placed into buildings where ongoing fire suppression is desired without the need for constant maintenance, such as in an airplane hanger. For similar reasons, the apparatus is also suitable for use in the onboard fire suppression systems of vehicles, such as ships, airplanes and heavy equipment.

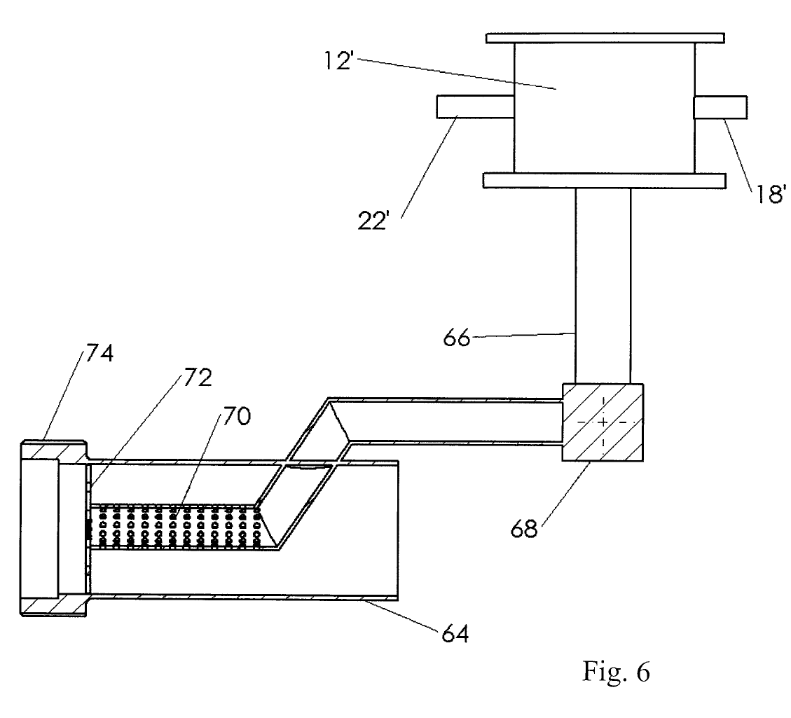

Because of the small size of the apparatus, it may be easily adapted for use in conjunction with a hand-held firehose, as best shown in FIG. 6. A rocket engine 12′, of the same configuration as that described above, is fuelled with hydrogen peroxide through feed line 18′ and with a propellant through feed line 22′. The exhaust gases created are propelled through gas feed line 66, and may be controlled with regulator 68. Gas feed line 66 passes into firehose 64, where the end of feed line 66 is submerged into the flow of water and foam concentrate flowing along firehose 64. The submerged end of feed line 66 preferably has perforations 70, from which the exhaust gases can be expelled at high pressure and velocity, ensuring good mixing and aeration of the water and foam concentrate in the firehose 64. The aerated foam then preferably passes through a screen 72, to further aerate and homogenize the foam before it is expelled through nozzle 74.

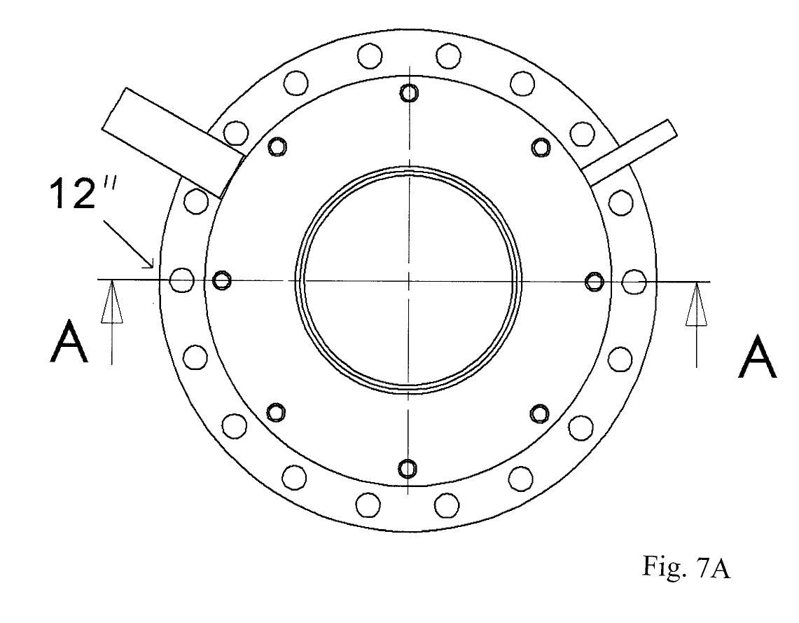

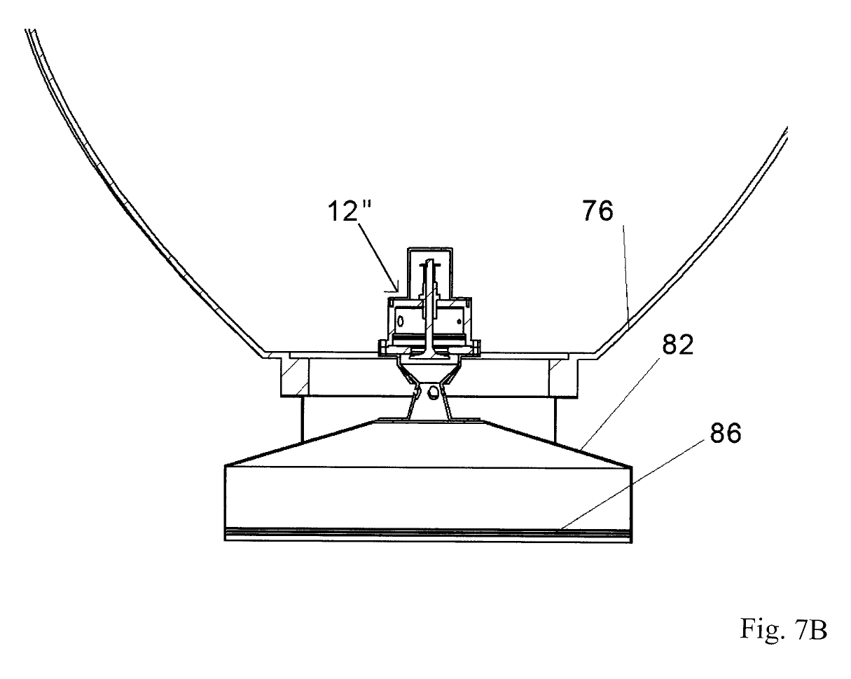

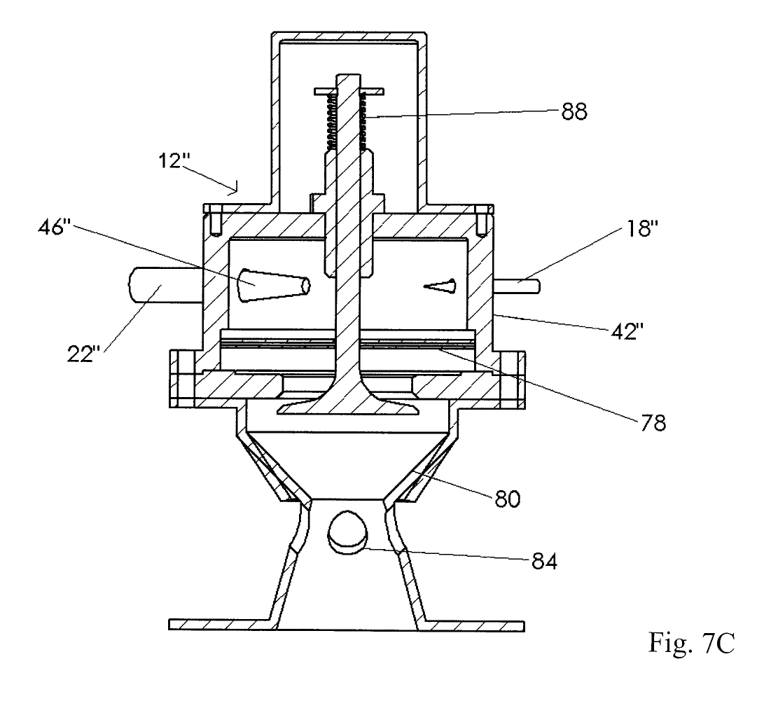

Further, the apparatus may be adapted for use in an underslung bucket on a helicopter, as best shown in FIGS. 7A-7C. A rocket engine 12″, in a similar configuration to those described above, is located within an underslung helicopter bucket 76. Water in bucket 76 mixes with foam concentrate to form foam. In the meantime, exhaust gases are produced within combustion chamber 42″ in rocket engine 12″ via the injection of hydrogen peroxide gas from feed line 18″ through suitable means such as injection plate 44″. The gas exothermically decomposes into oxygen and steam as it passes through the mesh catalyst 78. A suitable propellant, such as methanol or other alcohol, is injected into the oxygen and steam mixture from feed line 22″ via suitable means such as injector nozzle 46″, combusting the propellant, consuming the oxygen gas and producing heated exhaust gases. The exhaust gases are concentrated within collector shroud 80 and ejected in a downward direction, toward diffuser 82. Spring 88 assists in countering upward forces generated during the production and ejection of the exhaust gases, and prevents backflow of any water into the rocket engine 12″. As the exhaust gases pass venturi ports 84, the water and foam concentrate mixture is sucked into the gas flow and mixes with the exhaust gases in the diffuser 82. The resulting aerated foam passes through a mesh screen 86, further aerating and homogenizing the foam before it is expelled onto a fire.

Finally, the ability of the apparatus to produce large quantities of gas means that it is suitable for other applications requiring large quantities of compressed gas, when providing cylinders and/or compressors is inconvenient or expensive, such as on construction sites for operation of pneumatic tools.

It will be appreciated by those skilled in the art that other variations to the preferred embodiment described herein may be practiced without departing from the scope of the invention, such scope being properly defined by the following claims.

1. A portable apparatus for a compressed gas foam system comprising a first chamber for receiving a first fluid suitable for generating exhaust gases in a reaction wherein said exhaust gases from said reaction are directed through a water chamber attached to said first chamber to cause said gases to partially dissolve in said water and to pressurize said water chamber.

2. A portable apparatus for a compressed gas foam system comprising:
a first chamber attached to a second chamber;
said first chamber being adapted to receive a first fluid suitable for generating exhaust gases in a reaction; and
said second chamber being in operative relationship to said first chamber to allow said gases to be directed through said second chamber and through a volume of water in said second chamber whereby to partially dissolve said gases in said water and to pressurize said second chamber for expelling water therefrom under pressure.

3. The portable apparatus for a compressed gas foam system of claim 2 further comprising means for mixing said water under pressure with foam concentrate dispensed from a foam concentrate vessel to produce a stream of pressurized foam.

4. A compressed gas foam system comprising:
a first chamber for receiving a first fluid suitable for generating exhaust gases in a reaction and wherein said exhaust gases are used to pressurize a water chamber;
a gas pressure relief valve on said water chamber; and
an outlet of said gas pressure relief valve being in fluid communication with a mixer wherein foam concentrate and water under pressure are mixed.

5. The portable apparatus for a compressed gas foam system of claim 1 further comprising:
a gas pressure relief valve on said water chamber; and
an outlet of said gas pressure relief valve being in fluid communication with a mixer wherein foam concentrate and water under pressure are mixed.

6. The portable apparatus for a compressed gas foam system of claim 2 further comprising:
a gas pressure relief valve on said second chamber; and
an outlet of said gas pressure relief valve being in fluid communication with a mixer wherein foam concentrate and water under pressure are mixed.

7. A portable fire fighting apparatus to dispense fire fighting foam, comprising:
a first fluid vessel, adapted to store a quantity of water;
a rocket engine in fluid communication with the first fluid vessel to pressurize the first fluid vessel with exhaust from the rocket engine;
at least one fuel source in fluid communication with the rocket engine;
a first fluid conduit connecting the first fluid vessel to a mixing chamber;
a second fluid conduit connecting a second fluid vessel to the mixing chamber, the second fluid vessel being adapted to store a quantity of fire fighting foam concentrate;
an outlet connecting the mixing chamber to a dispensing mechanism; and
a gas conduit to transfer excess gas from the first fluid vessel to said mixing chamber.

8. A portable fire fighting apparatus to dispense fire fighting foam, comprising:
a first fluid vessel, adapted to store a quantity of water;
a rocket engine in fluid communication with the first fluid vessel to pressurize the first fluid vessel with exhaust from the rocket engine;
at least one fuel source in fluid communication with the rocket engine;
a first fluid conduit connecting the first fluid vessel to a mixing chamber;
a second fluid conduit connecting a second fluid vessel to the first fluid vessel, the second fluid vessel being adapted to store a quantity of fire fighting foam concentrate;
an outlet connecting the mixing chamber to a dispensing mechanism; and
a gas conduit to transfer excess gas from the first fluid vessel to said mixing chamber.

9. The portable apparatus for a compressed gas foam system of claim 1 further comprising:
a fluid vessel in fluid connection with said water chamber, said fluid vessel being adapted to store a quantity of foam concentrate;
a gas pressure relief valve on said water chamber; and
an outlet of said gas pressure relief valve being in fluid communication with a mixer wherein foam concentrate and water under pressure are mixed with gases vented through said gas pressure relief valve.

10. The portable apparatus for a compressed gas foam system of claim 2 further comprising:
a fluid vessel in fluid connection with said second chamber, said fluid vessel being adapted to store a quantity of foam concentrate;
a gas pressure relief valve on said water chamber; and
an outlet of said gas pressure relief valve being in fluid communication with a mixer wherein foam concentrate and water under pressure are mixed with gases vented through said gas pressure relief valve.
